(19) United States
(12) Patent Application Publication
(10) Pub. No.: US 2022/0256854 A1
(43) Pub. Date: Aug. 18, 2022

(54) PLANT TREATMENT COMPOSITION

(71) Applicant: Croda International Plc, Goole, East Yorkshire (GB)

(72) Inventors: Steven Robert Adams, Goole, East Yorkshire (GB); Andrew Mark Fowles, Goole, East Yorkshire (GB)

(73) Assignee: Croda International Plc, Goole, East Yorkshire (GB)

(21) Appl. No.: 17/619,404

(22) PCT Filed: Jun. 2, 2020
(86) PCT No.: PCT/EP2020/065226

§ 371 Date: Dec. 15, 2021

(30) Foreign Application Priority Data
Jun. 19, 2019 (GB) 1908776.6

(51) Int. Cl. A01N 43/90; C05D 9/00; A01N 57/20; A01N 47/28; A01N 37/02; A01P 13/00

(52) U.S. Cl. CPC A01N 43/90; C05D 9/00; A01P 13/00; A01N 47/28; A01N 37/02; A01N 57/20

(57) ABSTRACT

A plant treatment composition is described for supporting the efficacy of a herbicide in a weed and/or facilitating control of a weed with a herbicide in the presence of a mineral nutrient, the plant treatment composition comprising: a urea component; a xanthine component; an acidifier component; and optionally a mineral nutrient.

This invention relates to supporting the efficacy of herbicides. In particular, though not exclusively, the invention provides a method of supporting the efficacy of a herbicide in a weed. Other aspects of the invention provide a method of controlling a weed with a herbicide in the presence of a mineral nutrient applied to a crop comprising the weed, a method of supplying a mineral nutrient to a plant in a crop in the presence of a herbicide applied to control a weed in the crop, a plant treatment composition and a herbicidal combination.

The commercial production of crops is a highly intensive business where the main goal is to maximise productivity per hectare. In order to achieve this goal, agriculture is heavily dependent on the use of chemical products, such as fertilisers and pesticides, to improve yield and performance and to reduce yield loss due to weed growth and different types of pests and diseases.

Increasingly efficient herbicides have been developed by the agrochemical industry during the last decades to be used in various segments of agriculture, horticulture and gardening to reduce weed growth and thereby improve crop yield and crop performance.

Herbicides fall into two main categories, non-selective and selective treatment. Non-selective herbicides kill all plant species to which they are applied and selective herbicides kill specific plant species without seriously affecting others.

Typically, a selective herbicide is specific to a large class of plants species, such as grass species or broadleaf species. Unless the cultivated crop is naturally tolerant to a herbicide or has genetically-enhanced tolerance to a herbicide, it would be destroyed by a herbicide application. Without crop tolerance to a nonselective herbicide, their use would be limited to situations where the destruction of all plants was intended, such as clearing vegetation around railway track, roads, industrial sites, etc. Without tolerance in grass crops to grass-specific herbicides, their use would be limited to the cultivation of broadleaf crops, such as soybean, oilseed rape, and clover. Similarly, without tolerance in broadleaf crops to broadleaf-specific herbicides, their use would be limited to the cultivation of grass crops, such as corn, wheat, and rice.

Crop plants which are naturally tolerant to herbicide, or that have been genetically enhanced to tolerate herbicide, facilitate the use of both non-selective and selective herbicides in modern crop production systems. Genetically enhanced crop plants are commonly planted throughout the major crop growing regions of the world. Many of these crop plants are engineered to be resistant to commonly used herbicides such as glyphosate, glufosinate, 2,4-D (2,4-dichlorophenoxyacetic acid) and dicamba (3,6-dichloro-2-methoxybenzoic acid).

Both non-selective and selective herbicides may be applied to plant foliage or to the soil in which they are germinating and growing. Herbicides that are applied to the foliage must be absorbed and translocated to the site of action in the plant to be effective. Typically, commercial herbicide formulations contain a surfactant to assist the herbicide with adhering and spreading over a leaf surface, increasing the likelihood of absorption. However, the presence of surfactant in commercial herbicide formulations often is not sufficient to optimise herbicide efficacy.

Furthermore, particular challenges with regard to herbicide treatment arise when such treatment is to be combined with other treatments. For example, it has been found that, in some circumstances, concurrent treatment with mineral nutrients can reduce the efficacy of herbicides.

Accordingly, there is a need in the art to support the efficacy of herbicide treatments. It is an object of the present invention to address this problem and/or at least one other problem associated with the prior art.

From a first aspect, the invention provides a method of supporting the efficacy of a herbicide in a weed, the method comprising exposing the weed to a plant treatment composition comprising:
(i) a urea component;
(ii) a xanthine component; and
(iii) an acidifier component.

From a second aspect, the invention provides a method of controlling a weed with a herbicide in the presence of a mineral nutrient applied to a crop comprising the weed, the method comprising exposing the crop to a plant treatment composition comprising:
(i) a urea component;
(ii) a xanthine component; and
(iii) an acidifier component.

From a third aspect, the invention provides a method of supplying a mineral nutrient to a plant of a crop in the presence of a herbicide applied to control a weed of the crop, the method comprising exposing the crop to a plant treatment composition comprising:
(i) a urea component;
(ii) a xanthine component;
(iii) an acidifier component; and optionally
(iv) a mineral nutrient component.

From a fourth aspect, the invention provides a plant treatment composition for supporting the efficacy of a herbicide in a weed and/or facilitating control of a weed with a herbicide in the presence of a mineral nutrient, the plant treatment composition comprising:
(i) a urea component;
(ii) a xanthine component;
(iii) an acidifier component; and optionally
(iv) a mineral nutrient component.

From a fifth aspect, the invention provides a herbicidal combination comprising a herbicide and a plant treatment composition according to the fourth aspect of the invention.

It has been found that plant treatment compositions comprising or consisting of (i) a urea component; (ii) a xanthine component; and (iii) an acidifier component are useful in supporting herbicide efficacy.

The urea component comprises or consists of one or more urea compounds. Suitably, the urea component may be the sole urea component in the plant treatment composition.

The urea component may suitably comprise or consist of one or more compounds represented by the following Formula 1:

R¹R²N—C(═X)—NR³R⁴ (Formula 1)

wherein X═O or S, and wherein each of R¹, R², R³, R⁴ are independently selected from hydrogen, substituted or unsubstituted branched or unbranched alkyl, substituted or unsubstituted branched or unbranched heteroalkyl, substituted or unsubstituted branched or unbranched alkenyl, substituted or unsubstituted cycloalkyl, substituted or unsubstituted cyclohetroalkyl, substituted or unsubstituted aryl, substituted or unsubstituted heteroaryl.

Suitably, the urea component may comprise or consist of one or more unsymmetrically or symmetrically substituted ureas or thioureas, e.g. unsymmetrically or symmetrically substituted ureas of Formula I. Alternatively, the urea component may comprise or consist of one or more unsymmetrically or symmetrically substituted aryl ureas or aryl thioureas, e.g. unsymmetrically or symmetrically substituted aryl ureas of Formula I.

Suitably, the urea component may comprise or consist of urea (H₂NC(═O)NH₂), 1,3-dimethylurea, 1,3-diethylurea, 1,3-dipropylurea, 1,3-diisopropylurea, 1,3-dibutylurea, 1,3-dicyclohexylurea, 1,3-diphenylurea, 2-nitrodiphenylurea, methylurea, N,N′ and N,N dimethylurea, ethylurea, N,N′ and N,N diethylurea, propylurea, N,N′ and N,N dipropylurea, n-butyl urea, N,N′ and N,N di-n-butylurea, sec-butylurea, N,N′ and N,N di-sec-butylurea, isobutylurea, N,N′ and N,N di-iso-butylurea, t-butylurea, N,N′ and N,N t-butylurea, N,N′-bis(hydroxymethyl) urea, N-phenyl urea, tetramethyl urea, N,N′-dicyclohexyl urea, N,N′-trimethylene urea, N,N′-dibutylthiourea, isobenzylidene diurea, methylene urea, urea-triazone, tetrahydro-S-triazone, 5-methyleneuriedo-2-oxohexahydro-s-triazine or a mixture thereof. Preferably the urea component is selected from urea, 1,3-dimethylurea, isobenzylidene diurea, n-butylurea, methylene urea and urea-triazone. More preferably the urea component is selected from urea and 1,3-dimethylurea.

Suitably, the plant treatment composition may comprise the urea component in an amount in the range of from 1% to 60% w/w, in particular in the range of from 3% to 50% w/w, such as in the range of from 5% to 40% w/w, by weight based on the total weight of the composition. Most preferably, in the range from 8% to 33% w/w.

The xanthine component comprises or consists of one or more xanthine compounds. Suitably, the xanthine component may be the sole xanthine component in the plant treatment composition.

The term xanthine as used herein refers to optionally alkyl or halogen substituted dione derivatives of purine (7H-imidazo[4,5-d]pyrimidine). In plant cultivation, xanthines can be used as fungicides. They also find use as plant growth stimulators, see for example WO200704902.

The xanthine component may preferably comprise or consist of one or more, such as two or three, 2,6-dione derivatives of purine. The xanthines may be unsubstituted or mono-, di- or tri-substituted. The alkyl or halogen substitutions are preferably at one or more of the 1, 3, or 7 positions on the purine base molecule. The alkyl substitutions may be any C₁₋₄ alkyl, such as methyl, ethyl or propyl with methyl being preferred. The halogen substitutions may be fluorine, chlorine or bromine.

Preferred xanthines include, but are not limited to, caffeine (3,7-dihydro-1,3,7-trimethyl-1H -purine-2,6-dione), xanthine (3,7-dihydro-1 H-purine-2,6-dione), theobromine (3,7-dihydro-3,7-dimethyl-1H-purine-2,6-dione), theophylline (3,7-dihydro-1,3-dimethyl-1H-purine-2,6-dione), paraxanthine (1,7-dimethyl-3H-purine-2,6-dione), 8-chlorotheophylline (8-chloro-3,7-dihydro-1,3-dimethyl-1H-purine-2,6-dione), or mixtures thereof. Preferably the xanthine is selected from caffeine, theobromine, or theophylline. More preferably, the xanthine component comprises or consists of caffeine.

Suitably, the plant treatment composition may comprise the xanthine component in an amount in the range of from 0.001% to 10% w/w. Preferably, in the range of from 0.005% to 5% w/w. More preferably, in the range of from 0.01% to 1% w/w. Most preferably, in the range from 0.01% to 0.1% w/w, by weight based on the total weight of the composition.

The acidifier component comprises or consists of one or more acidifier compounds. Suitably, the acidifier component may be the sole acidifier component in the plant treatment composition.

The acidifier component may comprise or consist of one or more acids. In various embodiments, the acidifier component comprises or consists of nitric acid.

Additionally or alternatively, the acidifier component may comprise or consist of a weak acid. As used herein, the expression “weak acid” refers to an acid with a pKa in the range of from 2 to 7. Weak acids may be organic or inorganic. Preferably the acidifier component is a weak organic acid.

Examples of weak organic acids are carboxylic acids such as acetic acid, citric acid, humic acid, lactic acid, fulvic acid, oxalic acid or propanoic acid. Inorganic weak acids include phosphoric acid and hydrofluoric acid.

Preferably, the weak acid is selected from lactic acid, acetic acid, or citric acid. More preferably the weak acid is citric acid.

The presence of an acidifier may improve the uptake of nutrients, and particularly nitrogen and secondary or micronutrients, by plants. As a result, the inclusion of an acidifier brings about beneficial effects. These may include the enhancement of plant growth. More typically, the treatment will improve the quality of plant growth, and specifically the type of growth or growth habit may be enhanced as required. Generally, the nutrient content of the plant will be improved as a result of better nutrient uptake and distribution.

The concentration of the acidifier component may be chosen in accordance with a desired pH of the composition of the present invention. Optionally, the pH of the compositions of the present invention may be acidic, for example in the range of from 1 to 6.5, in particular in the range of from 2 to 6, such as in the range of 3 to 6. Particular pH values include, 3.5, 4, 4.5, 5 and 5.5 and any value in between those.

Suitably, the plant treatment composition may comprise the acidifier component in an amount in the range of from 0.01% to 10% w/w, in particular in the range of from 0.05% to 5% w/w, such as in the range of from 0.5% to 2% w/w, by weight based on the total weight of the composition.

The plant treatment composition may help to control a weed with a herbicide in the presence of a mineral nutrient. Indeed, the plant treatment composition may itself comprise a mineral nutrient component to be supplied to a plant in a crop, particularly in the presence of a herbicide applied to control a weed in the crop.

The mineral nutrient component may comprise or consist of one or more optionally chelated mineral nutrients. Suitably, the mineral nutrient component may be the sole mineral nutrient component in the plant treatment composition.

Mineral nutrients include, without limitation, any macronutrient, secondary nutrient, micronutrient, or mixture thereof.

Examples of macronutrients in the context of the invention include, but are not limited to, nitrogen, phosphorus, potassium, carbon, or mixtures thereof. Secondary nutrients include, but are not limited to, calcium, magnesium, sodium, chloride, sulphur, or mixtures thereof. Micronutrients include, but are not limited to, copper, cobalt, iron, manganese, boron, molybdenum, zinc, silicon, nickel, or mixtures thereof.

In one embodiment, the mineral nutrient component comprises a transition metal such as manganese, iron, copper, zinc, nickel, or a mixture thereof. In another embodiment, the mineral nutrient component comprises an alkali metal such as potassium or sodium, or a mixture thereof. In particular, the mineral nutrient may comprise potassium. In a further embodiment, the mineral nutrient component comprises an alkaline earth metal such as magnesium or calcium, or a mixture thereof. In particular, the mineral nutrient component may comprise manganese.

The mineral nutrient component may advantageously be introduced as a water-soluble salt. Particular examples of water- soluble nutrient salts for inclusion in the invention include, but are not limited to, nitrates, sulphates, chlorides and carbonates. Specific examples of water-soluble salts of mineral nutrients include, but are not limited to, manganese nitrate, manganese sulphate, manganese chloride, manganese carbonate, potassium nitrate, potassium sulphate, potassium chloride, potassium carbonate, calcium nitrate, calcium sulphate, calcium chloride, calcium carbonate, or mixtures thereof.

It can be beneficial to supply mineral nutrients, in particular micronutrients, in combination with a chelating agent, i.e. as chelated nutrients. Chelated mineral nutrients are protected from oxidation, precipitation, and immobilisation in certain conditions because the chelating agent can combine and form a ring encircling the nutrient.

Without wishing to be bound by theory, it is also thought that the presence of a chelating agent can reduce interaction of the nutrient with herbicide, which could otherwise lead to an antagonism or reduction in herbicide performance.

Suitably, the chelating agent may be an aminocarboxylate. Suitable aminocarboxylates include, but are not limited to, ethylenediaminetetracetates, N-hydroxyethylethylenediaminetriacetates, nitrilo-triacetates, ethylenediamine tetra-proprionates, triethylenetetraaminehexacetates, diethylenetriamine-pentaacetates, ethanoldiglycines, and mixtures thereof. In a preferred embodiment, the chelating agent is an ethylenediaminetetraacetate, for example such as ethylenediaminetetraacetic acid (EDTA).

Suitably, the plant treatment composition may comprise the mineral nutrient component in an amount in the range of from 0.1% to 20% w/w (nutrient equivalent), in particular in the range of from 1% to 10% w/w, more preferably in the range of from 3% to 8% w/w, by weight based on the total weight of the composition.

Thus, for example, where the nutrient component comprises manganese, the plant treatment composition may suitably comprise the nutrient component in an amount in the range of from 0.1% to 10% w/w, in particular in the range of from 2% to 9% w/w, such as in the range of from 4% to 8% w/w, by weight based on the total weight of the composition, expressed as amount Mn equivalent.

The plant treatment composition may also comprise one or more other agriculturally acceptable components. Examples of such components include, but are not limited to, water, plant health or growth promoters, plant oils, metabolic stimulating agents, emulsifiers, thickeners, suspension agents, dispersants, carriers or excipients, solubility agents, wetting agents, binding agents, essential oils, and mixtures thereof.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

In principle, it is possible to use all suitable carriers. Useful carriers include especially: for example ammonium salts and ground natural minerals such as kaolins, clays, talc, chalk, quartz, attapulgite, montmorillonite or diatomaceous earth, and ground synthetic materials such as finely divided silica, alumina and natural or synthetic silicates, resins, waxes and/or solid fertilisers. Mixtures of such carriers can likewise be used. Useful carriers for granules include: for example crushed and fractionated natural rocks such as calcite, marble, pumice, sepiolite, dolomite, and synthetic granules of inorganic and organic meals, and also granules of organic material such as sawdust, paper, coconut shells, corn cobs and tobacco stalks.

Thickeners are all substances which can be used in agrochemical compositions. Cellulose derivatives, acrylic acid derivatives, xanthan, modified clays and finely divided silica are preferred.

One or more such components may make up a balancing amount of the plant treatment composition.

Accordingly, exemplary compositions may comprise
(i) 3% -50% w/w of a urea component;
(ii) 0.001% -10% w/w of a xanthine component;
(iii) 0.01% -10% w/w of an acidifier component; and optionally
(iv) 0.1% -20% w/w of a mineral nutrient component
(v) 10% -96.889% w/w of an agriculturally acceptable component; preferably water or a water based liquid;

preferably
(i) 5% -40% w/w of a urea component;
(ii) 0.005% -5% w/w of a xanthine component;
(iii) 0.05% -5% w/w of an acidifier component; and optionally
(iv) 1% -10% w/w of a mineral nutrient component
(v) 60% -93.945% w/w of an agriculturally acceptable component; preferably water or a water based liquid;

more preferably
(i) 8% -33% w/w of a urea component;
(ii) 0.01% -1% w/w of a xanthine component;
(iii) 0. 5% -2% w/w of an acidifier component; and optionally
(iv) 3% -8% w/w of a mineral nutrient component
(v) 44% -88.49% w/w of an agriculturally acceptable component, preferably water or a water based liquid.

Suitably, the plant treatment composition is applied to a cultivation area of any crop.

A cultivation area may comprise any one of the following main crop plants: maize (Zea mays), soya bean (Glycine max), alfalfa (Medicago sativa), cotton (Gossypium sp.), sunflower (Helianthus sp.), Brassica oil seeds such as Brassica napus (e.g. canola, rapeseed), B. rapa, B. juncea (e.g. (field) mustard) and B. carinata, Arecaceae sp. (e.g. oilpalm, coconut), rice (Oryza sativa), wheat (Triticum sp.), sugar beet (Beta vulgaris), sugar cane (Saccharum spp.), oats (Avena sativa), rye (Secale cereale), barley (Hordeum vulgare), millet (e.g. from the tribes Eragrostideae and Paniceae) and sorghum (Sorghum bicolor), triticale, flax (Linum usitatissimum), nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

Preferably, a cultivation area to be treated comprises plants selected from the group consisting of fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans, broad beans and soybeans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

More preferably, crop plants comprised in a cultivation area treated with the composition according to the invention comprise soybeans.

The plant treatment composition may be applied to plants, weeds and crops in general in any suitable manner, e.g. by soil or foliar application. It may be applied to root systems, stems, seeds, grains, tubers, flowers, fruit, etc. as required. Examples of means of application include spraying, e.g. by means of an electrostatic or other conventional sprayer, or drip irrigation methods or fertigation systems, which involve application directly to the soil.

The plant treatment composition may be in the form of a concentrate. Concentrates are agrochemical compositions, which may be aqueous or non-aqueous, and which are designed to be diluted with water (or a water based liquid) to form the corresponding end use spray formulations. Said compositions include those in liquid form (such as solutions, emulsions, or dispersions) and in solid form (especially in water dispersible solid form) such as granules or powders.

Spray formulations are aqueous agrochemical formulations including all the components which it is desired to apply to the plants or their environment. Spray formulations can be made up by simple dilution of concentrates containing desired components (other than water), or by mixing of the individual components, or a combination of diluting a concentrate and adding further individual components or mixtures of components. Typically such end use mixing is carried out in the tank from which the formulation is sprayed, or alternatively in a holding tank for filling the spray tank. Such mixing and mixtures are typically termed tank mixing and tank mixtures.

According to the needs of the customer, concentrates thus formed may comprise typically up to 95 wt. % of the optional herbicide, urea, xanthine, acidifier, optional micronutrient, and optional herbicide components. Said concentrates may be diluted for use resulting in a dilute composition having an agrochemical active concentration of about 0.5 wt. % to about 1 wt. %. The plant treatment composition may suitably be applied to the cultivation area in an amount in the range of from 0.1 to 10 litres per hectare, such as in the range of from 0.5 to 10 litres per hectare, or even in the range of from 0.5 to 5 litres per hectare.

Upon dilution to form, for example, a spray formulation, the plant treatment composition will typically be present at a concentration of from 0.01 wt. % to 2 wt. %, more usually from 0.03 wt. % to 0.5 wt. % of the spray formulation. Further preferably, from 0.12 wt. % to 0.4 wt. % of the spray formulation.

When concentrates (solid or liquid) are used as the source of active agrochemical and/or adjuvant, the concentrates will typically be diluted to form the spray formulations. The dilution may be with from 1 to 10,000, particularly 10 to 1,000, times the total weight of the concentrate of water to form the spray formulation.

Where the agrochemical active is present in the aqueous end use formulation as solid particles, most usually it will be present as particles mainly of active agrochemical. However, if desired, the active agrochemical can be supported on a solid carrier e.g. silica or diatomaceous earth, which can be solid support, filler or diluent material as mentioned above.

Advantageously, the plant treatment composition may be mixed with the herbicide prior to application. In some embodiments, the plant treatment composition may even be co-formulated with the herbicide as a herbicidal combination.

Alternatively, the weed may be exposed to the herbicide prior to being exposed to the plant treatment composition. Suitably, the weed may be exposed to the herbicide less than 1 day, in particular less than 12 hours, preferably less than 6 hours prior to being exposed to the plant treatment composition. In yet another embodiment, the weed is exposed to the herbicide after being exposed to the plant treatment composition. Suitably, the weed is exposed to the herbicide less than 1 day, in particular less than 12 hours, preferably less than 6 hours after exposed to the plant treatment composition.

Suitably, the herbicide may comprise an organophosphorus compound. Examples of such compounds include, but are not limited to, bensulide, bialaphos, ethephon, fosamine, glufosinate, glyphosate, piperophos, and mixtures thereof. In one preferred embodiment, the present composition is suitable for increase the absorption capacity of a herbicidal compound such as glufosinate. In another preferred embodiment, the herbicidal compound for which the absorption capacity is increased is glyphosate.

In another embodiment, the herbicidal compound for which the absorption capacity is increased comprises an aromatic acid. Examples of aromatic acids include, but are not limited to, aminopyralid, chloramben, clopyralid, 2,4-D, 2,4 D choline salt, dicamba, picloram, pyrithiobac, quinclorac, quinmerac, or mixtures thereof. In a further preferred embodiment, the herbicidal compound for which the absorption capacity is increased is 2,4-D. In yet another preferred embodiment, the herbicidal compound for which the absorption capacity is increased is dicamba.

Examples of weeds to which the compositions of the present invention can be applied to include, but are not limited to, cheeseweed (Malva parviflora), chickweed (Stellaria media), white clover (Trifolium repens), cocklebur (Xanthium spp.), Asiatic dayflower (Commelina communis), dead nettle (Lamium spp.), red stem filaree (Erodium cicutarium), Carolina geranium (Geranium Carolinian), hemp (Sesbania spp.), marestail (Conyza canadensis), smartweed (Persicari spp. and Polygonum spp.) , indian mustard (Brassica juncea), redroot pigweed (Amaranthus retroflexus), smooth pigweed (Amaranthus hybridus), prickly sida (Sida spinose), cutleaf evening primrose (Oenothera laciniate), common purslane (Portulaca oleracea), common ragweed (Ambrosia artemisiifolia), giant ragweed (Ambrosia trifida), russian thistle (Echinops exaltatus), sheperd's purse (Capsella bursa-pastoris), Pennsylvania smartweed (Polygonum pensylvanicum), spurge (Euphorbia spp.), velvetleaf (Abutilon theophrasti), wild buckwheat (Eriogonum spp.), wild radish (Raphanus raphanistrum), purslane (Portulaca oleracea), sicklepod (Senna obtusifolia), morninglory (Ipomoea spp.), fleabane (Erigeron spp.), buckhorn plantain (Plantago spp.), palmer pigweed (Amaranthus palmeri), barnyardgrass (Echinochloa spp.), downy brome (Bromus tectorum), Persian darnel (Lolium persicum), Sandbur (Cenchrus spp.), Foxtail grasses (Alopecurus or Setaria spp.), wild oats (Avena spp.), cowcockle (Vaccaria spp.), flixweed (Descurainia sophia), Kochia grasses (Kochia spp.), ladysthumb (Persicaria maculosa), lambsquarter (Chenopodium berlandieri), prickly lettuce (Lactuca serriola), stinkgrass (Eragrostis cilianensis), witchgrass (Panicum capillare), beggarticks (Bidens spp.), goosegrass (Galium aparine), sourgrass (Digitaria insularis) and Jung lerice (Echinochloa colona), Palmer Amaranth (Amaranthus palmeri), Tall waterhemp (Amaranthus tuberculatus), Common Ragweed (Ambrosia artemisiifolia), Sourgrass (Digitaria insularis), Fleabane (Conyza spp.), Italian ryegrass (Lolium multiflorum), perennial ryegrass (Lolium perenne), rigid ryegrass (Lolium rigidum), woolly cupgrass (Eriochloa villosa), burcucumber (Cucumis anguria), common sunflower (Helianthus annuus), common waterhemp (Amaranthus rudis), marmelated grass (Brachiaria plantaginea), Signal grass (Brachiaria decumbens), Sandbur (Cenchrus echinatus), Crabgrass (Digitaria horizontalis), Morningglory (Ipomoea purpurea), redroot pigweed (Amaranthus retroflexus), Spurges (Euphorbia heterophylla), blue morningglory (Ipomoea indica), Boxwood (Buxus vahlii), Goosegrass (Eleusine indica), Joyweeds (Altemathera spp.), Dayflower (Commelina erecta), Fanpetals (Sida spp.), Coatbuttons (Tridax procumbens), Purple nutsedge (Cyperus rotundus), Common purslane (Portulaca oleracea), Buttonweed (Spermacoce spp.),), and combinations thereof.

The compositions of the present application may be prepared using any conventional techniques and methods. The compositions of the present application may be adapted for the means of application, e.g. prepared in a form suited to the required means of application. They may take the form of liquid or solid concentrates, which require dilution before application. They may be formed into, for example, water dispersible granules, slow or fast release granules, soluble concentrates, oil miscible liquids, ultra-low volume liquids, emulsifiable concentrates, dispersible concentrates, oil in water, and water in oil emulsions, micro-emulsions, suspension concentrates, aerosols, capsule suspensions and seed treatment formulations. Aerosol versions of the compositions may be prepared using a suitable propellant, for example n-butane. The form type chosen in any instance will depend upon the particular purpose envisaged and the physical, chemical and biological properties of the composition.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following examples, and in particular the individual features thereof, may be taken independently or in any combination. That is, all embodiments and/or features of any embodiment can be combined in any way and/or combination, unless such features are incompatible.

Other advantageous and optional features of the invention will be apparent from the following non-limiting examples.

### EXAMPLES

### Example 1: Absorption Rates of Herbicides in Brachiaria decumbens in the Presence of Manganese (Mn)

Studies were conducted to evaluate the effect of an Mn formulation containing manganese on the absorption of glufosinate (Study 1) and glyphosate (Study 2) using Brachiaria decumbens as a model weed species.

Study 1. Seed of Brachiaria decumbens were planted into pots in a greenhouse during January 2015. This experiment was designed as a randomized complete block with six replications. Each plant was sprayed in a spray chamber with one of six treatments (Table 1) 19 days after planting.

TABLE 1
Treatments applied to field trials at each trial location for Study 1.

| | | | | Mn | |
|---|---|---|---|---|---|
| | | Herbicide | Mn | formulation | Mn |
| Treatment | Herbicide | rate (I/ha) | formulation | rate (I/ha) | g/ha |
| 1 | None | n/a | None | n/a | n/a |
| 2 | Glufosinate | 2 | None | n/a | n/a |
| 3 | Glufosinate | 2 | Formulation A | 1.23 | 100 |
| 4 | Glufosinate | 2 | Formulation B | 1.2 | 100 |
| 5 | Glufosinate | 2 | Formulation C | 0.77 (kg/ha) | 100 |
| 6 | Glufosinate | 2 | Formulation D | 0.6 | 100 |

The composition of each formulation included in the treatment list for Study 1 (Table 1) is described below:
Formulation A having the following nominal composition:

| Component | Concentration (% w/w) |
|---|---|
| Caffeine | 0.02 |
| Urea | 11.11 |
| Manganese EDTA | 47.00* |
| Water | 40.87 |
| Citric acid | 1.00 |
| Total concentration | 100 |

*6.1% w/w Mn equivalent

Formulation B (comparative): commercial formulation comprising manganese sulfate@7% w/w Mn equivalent
Formulation C (comparative): commercial formulation comprising Mn EDTA@13% w/w Mn equivalent
Formulation D (comparative): commercial formulation comprising manganese chloride@14% w/w Mn equivalent

The amount of glufosinate on the plant surface (not absorbed) and that penetrated plant tissue (absorbed) was measured 36 hours after application of a treatment using chromatography and spectrometry.

The results of Study 1 (Table 2) show that Mn Formulation A improved glufosinate absorption relative to the glufosinate control and relative to all other commercial Mn formulations tested. In fact, each commercial Mn formulations reduced glufosinate absorption relative to the glufosinate control. In combination with glufosinate, all commercial Mn formulations resulted in lower glyphosate absorption than did Mn Formulation A.

TABLE 2
Relative amount of glufosinate absorbed when
applied with an Mn formulation in Study 1.

| | | Glufosinate | |
|---|---|---|---|
| | | Application | Absorbed |
| Mn formulation | Rate (I/ha) | rate (I/ha) | (%) |
| None (Glufosinate control) | 0 | 2 | 24.0 |
| Formulation A | 1.23 | 2 | 26.9 |
| Formulation B | 1.2 | 2 | 19.2 |
| Formulation C | 0.77 (kg/ha) | 2 | 22.7 |
| Formulation D | 0.6 | 2 | 18.7 |

Study 2. Seed of Brachiaria decumbens were planted into pots in a greenhouse during January 2015. This experiment was designed as a randomized complete block with six replications. Each plant was sprayed in a spray chamber with one of six treatments (Table 3) 25 days after planting.

TABLE 3
Treatments applied to field trials at each trial location for Study 2.

| | | | | Mn | |
|---|---|---|---|---|---|
| Treat- | | Herbicide | Mn | formulation | Mn |
| ment | Herbicide | rate (I/ha) | formulation | rate (I/ha) | g/ha |
| 1 | None | n/a | None | n/a | n/a |
| 2 | Glyphosate | 3.5 | None | 1 | n/a |
| 3 | Glyphosate | 3.5 | Formulation A | 1.23 | 100 |
| 4 | Glyphosate | 3.5 | Formulation B | 1.2 | 100 |
| 5 | Glyphosate | 3.5 | Formulation C | 0.77 (kg/ha) | 100 |
| 6 | Glyphosate | 3.5 | Formulation D | 0.6 | 100 |

The composition of each formulation included in the treatment list for Study 2 (Table 3) is the same as described in Example 1, Study 1.

The amount of glyphosate on the plant surface (not absorbed) and that penetrated plant tissue (absorbed) was measured four days after application (daa) of a treatment using chromatography and spectrometry.

The results of Study 2 (Table 4) show that Formulation A improved glyphosate absorption relative to the glyphosate control and relative to all other commercial Mn formulations tested. In fact, commercial Mn formulations B and D reduced glufosinate absorption relative to the glufosinate control. In combination with glyphosate, all commercial Mn formulations resulted in lower glyphosate absorption than did Formulation A.

TABLE 4
Relative amount of glyphosate absorbed
when applied with an Mn formulation in Study 2.

| | | Glyphosate | |
|---|---|---|---|
| | | Application | Absorbed |
| Mn formulation | Rate (I/ha) | rate (I/ha) | (%) |
| None (glyphosate control) | 0 | 3.5 | 21.0 |
| Formulation A | 1.23 | 3.5 | 24.7 |
| Formulation B | 1.2 | 3.5 | 13.3 |
| Formulation C | 0.77 (kg/ha) | 3.5 | 21.9 |
| Formulation D | 0.6 | 3.5 | 20.5 |

### Example 2: Effect of Foliar Applications of an Mn Formulation on the Effectiveness of Glyphosate to Control Broadleaf and Grass Weeds

A study was carried out to evaluate the effect of an Mn formulation on the efficacy of glyphosate, as measured by the control of broadleaf and grass weed species.

The trial was designed as a randomized complete block with six replications of five treatments (Table 5). The trial was planted at each of six locations in Brazil during the 2015 season. All treatments were applied at the V2 soybean growth stage using backpack sprayers. Soybeans were sown at a rate consistent with locally recommended practices into plots that were approximately 4 m long and 5 m wide.

TABLE 5
Treatments applied to field trials at each trial location.

| | | | | Mn | |
|---|---|---|---|---|---|
| Treat- | | Herbicide | Mn | formulation | Mn |
| ment | Herbicide | rate (I/ha) | formulation | rate (I/ha) | g/ha |
| 1 | None | n/a | None | n/a | n/a |
| 2 | Glyphosate | 1 | None | 1 | n/a |
| 3 | Glyphosate | 1 | Formulation A | 1 | 81 |
| 4 | Glyphosate | 1 | Formulation B | 1 | 84 |
| 5 | Glyphosate | 1 | Formulation C | 0.4 (kg/ha) | 52 |

The composition of each formulation included in the treatment list (Table 5) were as described in Example 1.

Data collected from a 1 m² area of each plot included the number of broadleaf and grass weeds, by genus and species, at the V2 soybean growth stage immediately prior to treatment application. The number of dead/damaged and undamaged weeds, by genus and species, was collected from the same 1 m² area of each plot 7 daa of a treatment. Treatment 2 (glyphosate alone) was used as the control.

The results show that Formulation A improved the efficacy of glyphosate on broadleaf and grass weeds (Table 6). Further, glyphosate efficacy was greater in combination with Formulation A than with the commercial Mn formulations tested.

TABLE 6
Control of broadleaf and grass weeds.

| | | Weed control (%) | |
|---|---|---|---|
| Herbicide | Mn formulation | Broadleaf weeds | Grass weeds |
| Glyphosate | None | 83.8 | 97.7 |
| Glyphosate | Formulation A | 84.7 | 98.1 |
| Glyphosate | Formulation B | 77.7 | 95.7 |
| Glyphosate | Formulation C | 83.7 | 95.8 |

### Example 3: Effect of Foliar Applications of an Mn Formulation on the Effectiveness of Glyphosate to Control Individual Grass and Broadleaf Weed Species

A study was conducted to evaluate the effect of an Mn formulation on glyphosate efficacy, as measured by the control of individual grass and broadleaf weed species.

The trial was designed as a randomized complete block with three replications of four treatments (Table 7). The trial was planted at one location in Brazil during March 2016. Weed control was assessed 7, 14, and 28 daa.

TABLE 7
Treatments applied to the field trial location.

| | | Herbicide | | Mn | |
|---|---|---|---|---|---|
| Treat- | | rate | Mn | formulation | Mn |
| ment | Herbicide | (I/ha) | formulation | rate (I/ha) | g/ha |
| 1 | Glyphosate | 1 | None | n/a | n/a |
| 2 | Glyphosate | 1 | Formulation A | 1 | 81 |
| 3 | Glyphosate | 2 | None | n/a | n/a |
| 4 | Glyphosate | 2 | Formulation A | 1 | 81 |

The composition of Formulation A was as described in Example 1.

The results show that the efficacy of glyphosate, at each of two different application rates, was improved when applied in combination with Formulation A for each of seven different weed species (Table 8).

TABLE 8
Treatment means across three replications and three assessment timings for each weed species.

| | Mn | Weed control (%) of individual weed species* | | | | | | | |
|---|---|---|---|---|---|---|---|---|---|
| Herbicide | formulation | BRAPL | BRADC | CCHEC | DIGHO | IPOA | AMARE | EPHHL | Ave |
| Glyphosate @ | None | 91.2 | 83.0 | 95.0 | 96.3 | 34.8 | 69.6 | 65.4 | 76.5 |
| 1 l/ha | | | | | | | | | |
| Glyphosate @ | Formulation | 93.7 | 82.9 | 98.7 | 97.6 | 35.0 | 80.6 | 67.0 | 79.4 |
| 1 l/ha | A @ 1 l/ha | | | | | | | | |
| Glyphosate @ | None | 95.9 | 90.2 | 98.7 | 99.0 | 52.6 | 84.7 | 77.4 | 85.5 |
| 2 l/ha | | | | | | | | | |
| Glyphosate @ | Formulation | 95.0 | 93.6 | 99.2 | 99.3 | 54.9 | 84.9 | 74.0 | 85.8 |
| 2 l/ha | A @ 1 l/ha | | | | | | | | |

*BRAPL = Brachiaria plantaginea; BRADC = Brachiaria decumbens; CCHEC = Cenchrus echinatus;
DIGHO = Digitaria horizontalis; IPOAC = Ipomoea acuminate; AMARE = Amaranthus retroflexus;
EPHHL = Euphorbia heterophylla.

### Example 4: Effect of Foliar Applications of an Mn Formulation on the Effectiveness of Glufosinate to Control Individual Grass and Broadleaf Weed Species

A study was conducted to evaluate the effect of an Mn formulation on glufosinate efficacy, as measured by the control of individual grass and broadleaf weed species.

The trial was designed as a randomized complete block with three replications of four treatments (Table 9). The trial was planted at one location in Brazil during March 2016. Weed control was assessed 7, 14, and 28 daa.

TABLE 9
Treatments applied to the field trial location.

| | | Herbicide | | Mn | |
|---|---|---|---|---|---|
| Treat- | | rate | Mn | formulation | Mn |
| ment | Herbicide | (I/ha) | formulation | rate (I/ha) | g/ha |
| 1 | Glufosinate | 1.5 | None | n/a | n/a |
| 2 | Glufosinate | 1.5 | Formulation A | 1 | 81 |
| 3 | Glufosinate | 2.5 | None | n/a | n/a |
| 4 | Glufosinate | 2.5 | Formulation A | 1 | 81 |

The composition of Formulation A was as described in Example 1.

The results show that the efficacy of glufosinate, at each of two different applications rates, was improved when applied in combination with Formulation A for each of five different weed species (Table 10).

TABLE 10
Treatment means across three replications and three assessment timings for each weed species.

| | Mn | Weed control (%) of individual weed species* | | | | | |
|---|---|---|---|---|---|---|---|
| Herbicide | formulation | BRAPL | BRADC | CCHEC | DIGHO | IPOAC | Ave |
| Glufosinate @ | None | 78.6 | 89.3 | 62.8 | 67.0 | 96.7 | 78.9 |
| 1.5 l/ha | | | | | | | |
| Glufosinate @ | Formulation | 84.2 | 89.4 | 65.6 | 64.4 | 97.8 | 80.3 |
| 1.5 l/ha | A @ 1 l/ha | | | | | | |
| Glufosinate @ | None | 88.2 | 91.1 | 78.7 | 82.9 | 100.0 | 88.2 |
| 2.5 l/ha | | | | | | | |
| Glufosinate @ | Formulation | 91.6 | 92.8 | 82.3 | 88.2 | 100.0 | 91.0 |
| 2.5 l/ha | A @ 1 l/ha | | | | | | |

*BRAPL = Brachiaria plantaginea; BRADC = Brachiaria decumbens; CCHEC = Cenchrus echinatus;
DIGHO = Digitaria horizontalis; IPOAC = Ipomoea acuminate.

### Example 5. Effect of Foliar Applications of a Potassium (K) Formulation on the Effectiveness of Glyphosate to Control Weed Species

Three studies were conducted to evaluate the effect of a K formulation on glyphosate efficacy, as measured by the control of weed species.

Study 1. The trial was designed as a randomized complete block with two replications of five treatments (Table 11). The trial was planted at one location in Brazil during 2011. Weed control was assessed 14 and 25 daa.

TABLE 11
Treatments applied to the field trial location.

| | | Herbicide | | |
|---|---|---|---|---|
| Treat- | | rate | | Formulation |
| ment | Herbicide | (I/ha) | Formulation | rate (I/ha) |
| 1 | Glyphosate | 2 | None | n/a |
| 2 | Glyphosate | 2 | Formulation E | 2.5 |
| 3 | Glyphosate | 2 | Formulation E | 5 |
| 4 | Glyphosate | 2 | Formulation E | 10 |

The composition of the formulation included in the treatment list for Study 1 (Table 11) is described below:
Formulation E having the following nominal composition:

| Component | Concentration (% w/w) |
|---|---|
| Caffeine | 0.02 |
| Urea | 29.80 |
| Potassium nitrate | 11.00 |
| Water | 53.15 |
| Citric acid | 2.00 |
| Potassium chloride | 3.40 |
| Molasses | 0.63 |
| Total concentration | 100.00 |

The results show that the efficacy of glyphosate, as measured by percent weed control, improved at each of two different assessment dates when applied in combination with Formulation E at each of three different formulation rates (Table 12).

TABLE 12
Treatment means for each weed control assessment.

| Glyphosate | | Formulation | Weed control (%) | |
|---|---|---|---|---|
| @ 2 I/ha | Formulation | rate (I/ha) | 14 daa | 25 daa |
| Glyphosate | None | n/a | 85 | 96.5 |
| Glyphosate | Formulation E | 2.5 | 90 | 98 |
| Glyphosate | Formulation E | 5 | 87.5 | 98 |
| Glyphosate | Formulation E | 10 | 90 | 98 |

Study 2. The trial was designed as a randomized complete block with two replications of six treatments (Table 13). The trial was planted at one location in Brazil during 2011. Weed control was assessed 14 and 25 daa.

TABLE 13
Treatments applied to the field trial location.

| Treat- | | Herbicide | | Formulation |
|---|---|---|---|---|
| ment | Herbicide | rate (I/ha) | Formulation | rate (I/ha) |
| 1 | Glyphosate | 2 | None | n/a |
| 2 | Glyphosate | 2 | Formulation E | 5 |

The composition of Formulation E was as described in Example 5, Study 1.

The results show that the efficacy of glyphosate, as measured by percent weed control, was improved when applied in combination with Formulation E 14 and 25 daa (Table 14).

TABLE 14
Treatment means for each weed control assessment.

| Glyphosate | Formulation | Weed control (%) | |
|---|---|---|---|
| @ 2 I/ha | @ 5 I/ha | 14 daa | 25 daa |
| Glyphosate | None | 82.5 | 96.5 |
| Glyphosate | Formulation E | 85 | 98 |

Study 3. The trial was designed as a randomized complete block with two replications of six treatments (Table 15). The trial was planted at one location in Brazil during 2011. Weed control was assessed 14 and 25 daa.

TABLE 15
Treatments applied to the field trial location.

| Treat- | | Herbicide | | Formulation |
|---|---|---|---|---|
| ment | Herbicide | rate (I/ha) | Formulation | rate (I/ha) |
| 1 | Glyphosate | 2 | None | n/a |
| 2 | Glyphosate | 2 | Formulation E | 5 |

The composition of Formulation E was as described in Example 5, Study 1.

The results show that the efficacy of glyphosate, as measured by percent weed control, was improved when applied in combination with Formulation E 14 and 25 daa (Table 16).

TABLE 16
Treatment means for each weed control assessment.

| Glyphosate | Formulation | Weed control (%) | |
|---|---|---|---|
| @ 2 I/ha | @ 5 I/ha | 14 daa | 25 daa |
| Glyphosate | None | 85 | 90 |
| Glyphosate | Formulation E | 87.5 | 92.5 |

1. A method of supporting the efficacy of a herbicide in a weed, the method comprising exposing the weed to a plant treatment composition comprising:
(i) a urea component;
(ii) a xanthine component; and
(iii) an acidifier component.

2. The method of claim 1, wherein the urea component comprises or consists of one or more compounds having the formula R₁R₂NC(═X)NR₃R₄, wherein X═O or S, and wherein each of R¹, R², R³, R⁴ are independently selected from hydrogen, substituted or unsubstituted branched or unbranched alkyl, substituted or unsubstituted branched or unbranched heteroalkyl, substituted or unsubstituted branched or unbranched alkenyl, substituted or unsubstituted cycloalkyl, substituted or unsubstituted cyclohetroalkyl, substituted or unsubstituted aryl, substituted or unsubstituted heteroaryl.

3. The method of claim 1, wherein the urea component comprises or consists of urea (H2NC(═O)NH2), 1,3-dimethylurea, 1,3-diethylurea, 1,3-dipropylurea, 1,3-diisopropylurea, 1,3-dibutylurea, 1,3-dicyclohexylurea, 1,3-diphenylurea, 2-nitrodiphenylurea, methylurea, N,N′ and N,N dimethylurea, ethylurea, N,N′ and N,N diethylurea, propylurea, N,N′ and N,N dipropylurea, n-butyl urea, N,N′ and N,N di-n-butylurea, sec-butylurea, N,N′ and N,N di-sec-butylurea, isobutylurea, N,N′ and N,N di-iso-butylurea, t-butylurea, N,N′ and N,N t-butylurea, N,N′-bis(hydroxymethyl) urea, N-phenyl urea, tetramethyl urea, N,N′-dicyclohexyl urea, N,N′-trimethylene urea, N,N′-dibutylthiourea, isobenzylidene diurea, methylene urea, urea-triazone, tetrahydro-S-triazone, 5-methyleneuriedo-2-oxohexahydro-s-triazine or a mixture thereof.

4. The method claim 1, wherein the xanthine component comprises or consists of caffeine, theobromine, or theophylline.

5. The method of claim 1, wherein the acidifier component comprises or consists of one or more carboxylic acids, optionally citric acid.

6. A method of controlling a weed with a herbicide in the presence of a mineral nutrient applied to a crop comprising the weed, the method comprising exposing the crop to a plant treatment composition comprising:
(i) a urea component;
(ii) a xanthine component;
(iii) an acidifier component.

7. A method of supplying a mineral nutrient to a plant in a crop in the presence of a herbicide applied to control a weed in the crop, the method comprising exposing the crop to a plant treatment composition comprising:
(i) a urea component;
(ii) a xanthine component;
(iii) an acidifier component; and
(iv) a mineral nutrient component.

8. A plant treatment composition for supporting the efficacy of a herbicide in a weed and/or facilitating control of a weed with a herbicide in the presence of a mineral nutrient, the plant treatment composition comprising:
(i) a urea component;
(ii) a xanthine component;
(iii) an acidifier component; and optionally
(iv) a mineral nutrient component.

9. The method claim 6 wherein the urea component comprises or consists of one or more compounds having the formula R₁R₂NC(═X)NR₃R₄, wherein X═O or S, and wherein each of R¹, R², R³, R⁴ are independently selected from hydrogen, substituted or unsubstituted branched or unbranched alkyl, substituted or unsubstituted branched or unbranched heteroalkyl, substituted or unsubstituted branched or unbranched alkenyl, substituted or unsubstituted cycloalkyl, substituted or unsubstituted cyclohetroalkyl, substituted or unsubstituted aryl, substituted or unsubstituted heteroaryl; wherein the xanthine component comprises or consists of caffeine, theobromine, or theophylline; and wherein the acidifier component comprises or consists of one or more carboxylic acids, optionally citric acid.

10. The method of claim 6 wherein the mineral nutrient comprises or consists of a chelated manganese compound.

11. The method of claim 1, wherein the weed is in a soybean crop.

12. A plant treatment composition according to claim 8 comprising:
(i) in a range of from 5 to 30% w/w of the urea component;
(ii) in a range of from 0.01 to 1% w/w of the xanthine component;
(iii) in a range of from 0.5 to 2% w/w of the acidifier component;
and
(iv) in a range of from 3 to 6.5% w/w of a Mn equivalent chelated manganese.

13. A herbicidal combination comprising a herbicide and a plant treatment composition according to claim 8.

14. The method of claim 1, wherein the herbicide comprises or consists of glufosinate, glyphosate, 2,4-D, dicamba or combinations thereof.
